(19) United States
(12) Patent Application Publication
(10) Pub. No.: US 2003/0053856 A1
(43) Pub. Date: Mar. 20, 2003

(54) Reinforcing bar connector

(76) Inventor: Ching-Cheng Chen, Hsintien City (TW)

Correspondence Address: BACON & THOMAS, PLLC, 625 SLATERS LANE, FOURTH FLOOR, ALEXANDRIA, VA, 22314

(21) Appl. No.: 10/093,700

(22) Filed: Mar. 11, 2002

(30) Foreign Application Priority Data
Sep. 14, 2001 (TW) 90215934

(51) Int. Cl. F16D 1/00; B25G 3/00

(52) U.S. Cl. 403/305

(57) ABSTRACT

A reinforcing bar connector is disclosed, which includes two male connectors respectively welded to one end of each of two reinforcing bars, each male connector having at least one radially extended protrusion, two female connector elements respectively fitted over the periphery of said male connectors and abutted radially against each other to hold said male connectors in a line, each female connector element having at least two concavities for engagement with the at least one radially extended protrusion of each of the male connectors, and a sleeve axially sleeved onto the female connector elements to lock the female connector elements.

### BACKGROUND OF THE INVENTION

1. Field of the Invention

The present invention relates to a connector and, more particularly, to reinforcing bar connector, which enables the inspector to check the connection of the reinforcing bars visually.

2. Description of Related Art

It has been more than two decades since the invention of reinforcing bar connector. Nowadays, various reinforcing bar connectors are known. FIG. 1 shows a tubular steel reinforcing bar connector coupled to one end of each of two reinforcing bars and then deformed and fixedly secured to the reinforcing bars by a hydraulic press. FIG. 2 shows another design of reinforcing bar connector according to the prior art. According to this design, the reinforcing bar connector comprises two threaded male connectors respectively fixedly fastened to one end of each of two reinforcing bars to be connected, and a female screw nut threaded onto the threaded male connectors to secure the reinforcing bars axially in a line. There is known another design of reinforcing bar connector in which a sleeve is sleeved onto one end of each of two reinforcing bars to be connected, and a bonding agent for example, epoxy resin is stuffed in the sleeve to secure the sleeve and the reinforcing bars together. The common drawback of the known reinforcing bar connectors is the job-site inspection. When checking a big number of reinforcing bar connectors at the job-site, it is difficult to inspect every piece of the reinforcing bar connectors, therefore sampling inspection is commonly adopted. However, sampling inspection cannot guarantee all reinforcing bar connectors are reliable, resulting in high risk of engineering safety.

Therefore, it is desirable to provide a reinforcing bar connector that eliminates the aforesaid problem.

### SUMMARY OF THE INVENTION

The main object of the present invention is to provide a reinforcing bar connector, which enables the inspector to check the reliability of the connection of the reinforcing bars visually.

To achieve this and other objects of the present invention, the reinforcing bar connector comprises two male connectors respectively welded to one end of each of two reinforcing bars, each male connector having at least one radially extended protrusion, two female connector elements respectively fitted over the periphery of said male connectors and abutted radially against each other to hold said male connectors in a line, each female connector element having at least two concavities for engagement with the at least one radially extended protrusion of each of the male connectors, and a sleeve axially sleeved onto the female connector elements to lock the female connector elements.

Other objects, advantages, and novel features of the invention will become more apparent from the following detailed description when taken in conjunction with the accompanying drawings.

### BRIEF DESCRIPTION OF THE DRAWINGS

FIG. 1 illustrates a reinforcing bar connector fastened to two reinforcing bars according to the prior art.

FIG. 2 illustrates another reinforcing bar connector fastened to two reinforcing bars according to another prior art.

FIG. 3 is an exploded view of the preferred embodiment of the present invention.

FIG. 4 is a sectional assembly view of the preferred embodiment of the present invention.

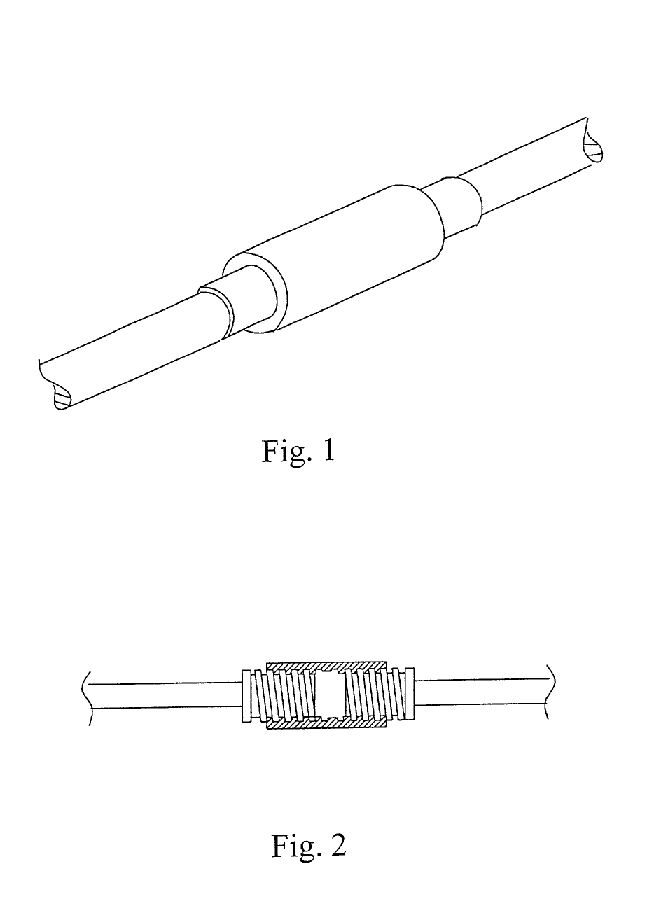

### DETAILED DESCRIPTION OF THE PREFERRED EMBODIMENT

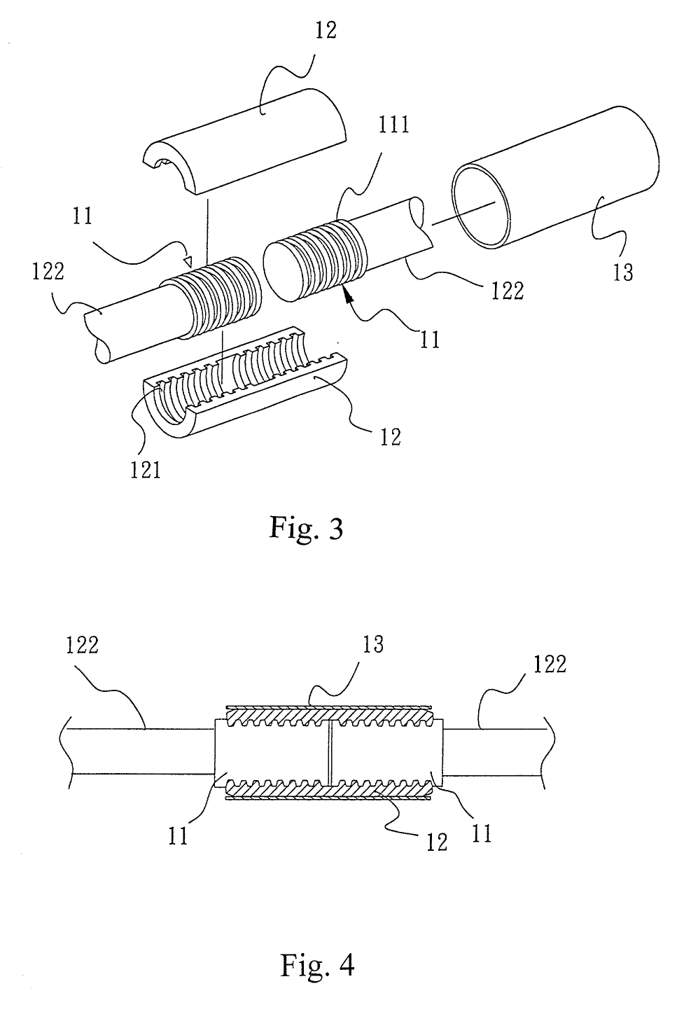

With reference to FIG. 3, a reinforcing bar connector is shown comprising two male connectors 11 respectively welded to one end of each of two reinforcing bars 122, two female connector elements 12 fastened to the male connectors 11 and abutted radially against each other and to hold the male connectors 11 in a line and to prohibit the male connectors 11 from axial movement relative to each other, and a sleeve 13 sleeved onto the female connector elements 12 and to prohibit the male connectors 11 from radial movement. The male connectors 11 are cylindrical members each having a plurality of radially extended protrusions 111. The female connector elements 12 are semicircular tubes matching each other, each being about two times the length of each male connector 11 and having a plurality of concavities 121 disposed at an inner side for engagement with the radially extended protrusions 111 of each of the male connectors 11.

Referring to FIG. 4, the sleeve 13 is sleeved onto the abutted female connector elements 12 around the male connectors 11 of the reinforcing bars 122. The sleeve 13 is machine cast or forged. When the sleeve 13 and the female connector elements 12 are overlapped, the male connectors 11 are firmly secured together. During inspection, the inspector needs only to visually check if the sleeve 13 has been completely sleeved onto the ends of the female connector elements 12. Therefore, accurate inspection can be easily 100% ensured.

The male connectors can have any of a variety of shapes. For example, the male connectors can be made having a cylindrical or hexagonal shape. The shape of the female connector elements is preferably shaped like a semicircular tube or any other half-tube shape abutted radially against one another to completely cover over the male connectors. The shape of the sleeve can be shaped like a round tube or hexagonal tube or any other substantially equivalent tube. The method of welding the male connectors to the reinforcing bars can be the friction welding, or penetration welding, or any other substantially equivalent welding method. The shape of the radially extended protrusions of the male connectors is preferably serrated.

Instead of the conventional reinforcing bar connector design of using a hydraulic press to die cast or connect the parts, the present invention engage the radially extended protrusions 111 of the male connectors 11 into the concavities 121 of the female connector elements 12 and then tightly sleeve the sleeve 13 onto the abutted female connector elements 12 around the male connectors 11 to connect the reinforcing bars 122 firmly together. This reinforcing bar connector design simplifies the installation procedure and the working efficiency. By means of visually checking the overlap condition of the sleeve 13 on the female connector elements 12, the inspector “easily” accurately inspects the quality of the reinforcing bar connector. Therefore, the present invention achieves 100% safety inspection that is not achievable in conventional reinforcing bar connectors.

Although the present invention has been explained in relation to its preferred embodiment, it is to be understood that many other possible modifications and variations can be made without departing from the spirit and scope of the invention as hereinafter claimed.

What is claimed is:

1. A reinforcing bar connector adapted for connecting two reinforcing bars axially in a line, comprising:
two male connectors respectively fixedly connected to one end of each of two reinforcing bars, said male connectors each having at least one radially extended protrusion;
two female connector elements respectively fitted over the periphery of said male connectors and abutted radially against each other to hold said male connectors in a line, said female connector elements each having at least two concavities for engagement with the at least one radially extended protrusion of each of said male connectors; and
a sleeve axially sleeved onto said female connector elements to lock said female connector elements.

2. The reinforcing bar connector as claimed in claim 1, wherein said male connectors are shaped like a cylinder; said female connector elements are shaped like a semicircular tube; said sleeve are shaped like a round tube.

3. The reinforcing bar connector as claimed in claim 1, wherein said male connectors are respectively welded to one end of said reinforcing bars.

4. The reinforcing bar connector as claimed in claim 1, wherein said male connectors are respectively welded to one end of said reinforcing bars by friction welding.

5. The reinforcing bar connector as claimed in claim 1, wherein said male connectors are respectively welded to one end of said reinforcing bars by penetration welding.

6. The reinforcing bar connector as claimed in claim 1, wherein said at least one radially extended protrusion each is serrated.
